(19) United States
(12) Patent Application Publication
(10) Pub. No.: US 2025/0332953 A1
(43) Pub. Date: Oct. 30, 2025

(54) BATTERY ATTACHMENT APPARATUS AND VEHICLE

(71) Applicant: Isuzu Motors Limited, Yokohama-shi (JP)

(72) Inventors: Takashi MIZUKI, Fujisawa-shi (JP); Shigeki MATSUO, Fujisawa-shi (JP)

(73) Assignee: Isuzu Motors Limited, Yokohama-shi (JP)

(21) Appl. No.: 19/058,127

(22) Filed: Feb. 20, 2025

(30) Foreign Application Priority Data
Apr. 30, 2024 (JP) 2024-073917

(51) Int. Cl. B60L 53/80; H01M 50/249; H01M 50/262

(52) U.S. Cl. CPC B60L 53/80; H01M 50/249; H01M 50/262; H01M 2220/20

(57) ABSTRACT

Battery attachment apparatus 1 according to the present disclosure includes placing table 10 on which battery E is placed, and slide rail base 20 that supports placing table 10 in a slidable manner. Placing table 10 includes latch 11 including hook 11b, spring 12 that applies a pulling force to the second end side of latch 11, link rod 14 connected to spring 12, and release cam 15 that is rotatably connected to link rod 14. As placing table 10 slides with respect to slide rail base 20 and the rotation angle of release cam 15 changes, the pulling force of spring 12 changes and the engaged state between hook 11b and striker Ea changes, thus switching between the lock/unlock of the holding state of battery E.

### TECHNICAL FIELD

The present disclosure relates to a battery attachment apparatus and a vehicle.

### BACKGROUND ART

In the related art, electric vehicles (for example, electric automobiles and electric scooters) equipped with a battery as a drive power source are known.

In recent years, such electric vehicles have increasingly adopted battery exchange systems. Such battery exchange systems are generally designed based on the concept that when the stored power of the battery mounted on a vehicle is depleted, the battery is exchanged with another battery fully charged at a battery exchange station, instead of charging the battery each time.

### CITATION LIST

### Patent Literature

### PTL 1

Japanese Patent Application No. 2023-134543

### PTL 2

Japanese Patent Application No. 2023-014064

### SUMMARY OF INVENTION

### Technical Problem

The inventor of the present application has considered adopting a battery attachment apparatus that can pull out and store a battery between a storage position on the vehicle inner side and an attachment/detachment position on the vehicle outer side via a slide part in order to smoothly exchange a battery mounted on a vehicle of this type (see, for example, PTLs 1 and 2).

Examples of such battery attachment apparatuses include a battery attachment apparatus including a placing table on which a battery is placed, and a slide rail base that supports the placing table in a slidable manner, in which the battery is detachable (that is, unlocked) when the placing table is located at an attachment/detachment position on the vehicle outside on the slide rail base, whereas the battery is locked when the placing table is located at a storage position on the vehicle inside on the slide rail base. With such a configuration, it is possible to easily attach and detach a battery to and from a vehicle at a battery exchange station.

Note that the above-described state in which the battery is locked means a state in which the battery cannot be removed from the placing table. Further, the state in which the battery is unlocked means a state in which the battery can be removed from the placing table (the same applies hereinafter).

During the study of the optimal design for a battery attachment apparatus, the inventor of the present application identified a problem with the current battery attachment apparatus in that it requires a manual release operation of the latch that locks the battery, which leaves room for improvement in simplifying or fully automating the battery exchange work. Further, the current battery attachment apparatus also requires an operation mechanism such as a lever for releasing the latch, which may lead to an increase in the number of components.

The present disclosure has been made in view of the above problems, and an object thereof is to provide a battery attachment apparatus that makes it easier to exchange a battery.

### Solution to Problem

To solve the above-described problems, a battery attachment apparatus according to the present invention includes: a placing table on which a battery is placed; and a slide rail base configured to support the placing table in a slidable manner, wherein the slide rail base includes a fixing pin for cam rotation, in which the placing table includes a latch rotatably attached to the placing table and including a hook configured to engage with a striker attached to the battery, a first cam configured to rotate by coming into contact with the fixing pin when the placing table slides, and a spring and a link rod configured to connect the latch and the first cam, and in which the spring includes a first end connected to the latch and a second end connected to the link rod in a swingable manner such that a pulling force is exerted on the first end side.

Further, a vehicle according to another aspect is a vehicle including the above-described battery attachment apparatus.

### Advantageous Effects of Invention

According to the battery attachment apparatus of the present invention, battery exchange can be more easily performed.

### BRIEF DESCRIPTION OF DRAWINGS

FIG. 1 is a diagram illustrating an example of an application position of a battery attachment apparatus;

FIG. 2 is a perspective view illustrating an example of an overall configuration of the battery attachment apparatus;

FIG. 3 is a diagram illustrating a slide movement of a placing table in the battery attachment apparatus;

FIG. 4 is a diagram illustrating an example of a configuration of a lock mechanism of the battery attachment apparatus;

FIG. 5 is a diagram illustrating an example of a configuration of a striker attached to a battery;

FIG. 6 is a diagram illustrating an operation of the lock mechanism of the battery attachment apparatus (locked state);

FIG. 7 is a diagram illustrating an operation of the lock mechanism of the battery attachment apparatus (transition state between the locked state and the unlocked state); and

FIG. 8 is a diagram illustrating an operation of the lock mechanism of the battery attachment apparatus (unlocked state).

### DESCRIPTION OF EMBODIMENTS

Hereinafter, preferred embodiments of the present disclosure will be described in detail with reference to the accompanying drawings. In the present specification and drawings, components having substantially the same functions are denoted by the same reference numerals, and redundant descriptions are omitted.

Note that each drawing illustrates a common orthogonal coordinate system (X, Y, Z) to clarify the positional relationship of each configuration. The positive direction of the Z-axis represents the vertically upward direction of the vehicle, the positive direction of the X-axis represents the forward direction of the vehicle, and the positive direction of the Y-axis represents the lateral direction of the vehicle.

Hereinafter, an exemplary configuration of a battery attachment apparatus (hereinafter referred to as “battery attachment apparatus 1”) according to an embodiment of the present invention will be described.

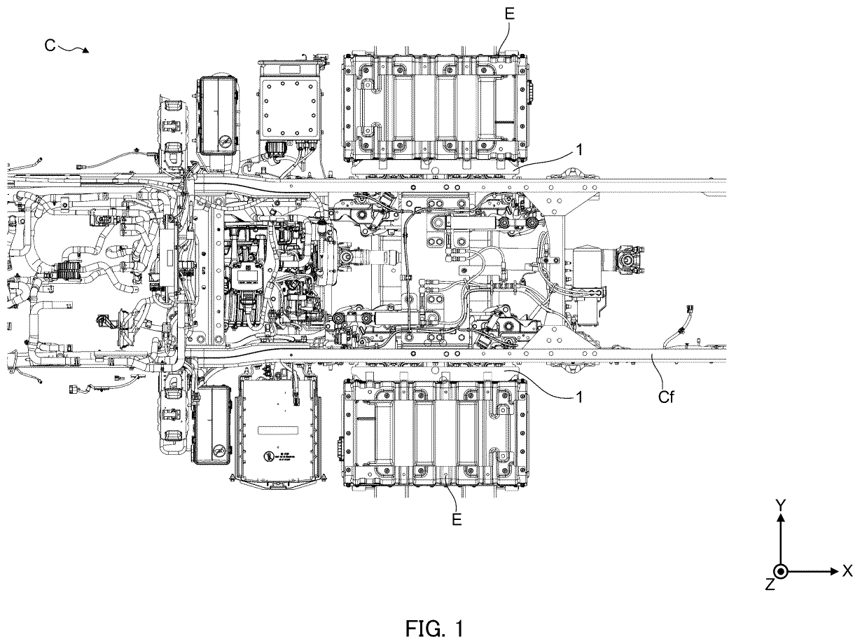

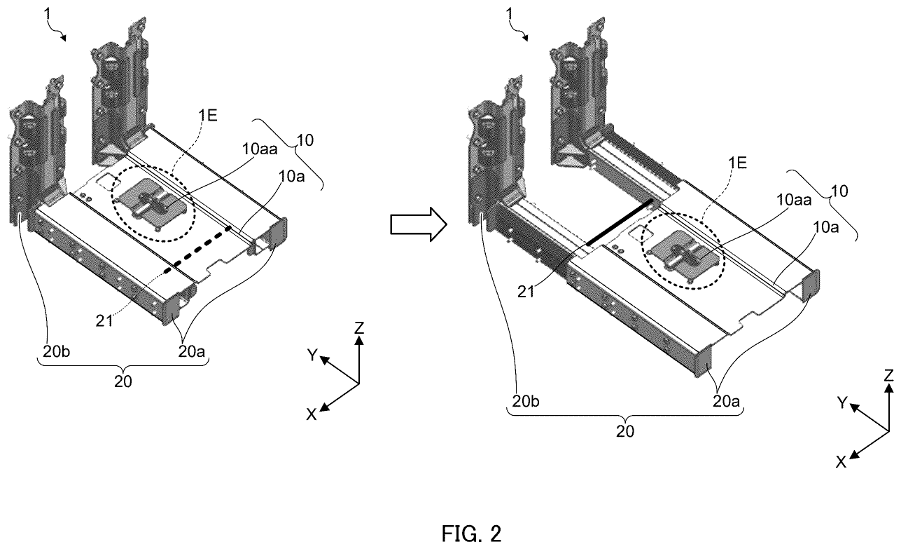

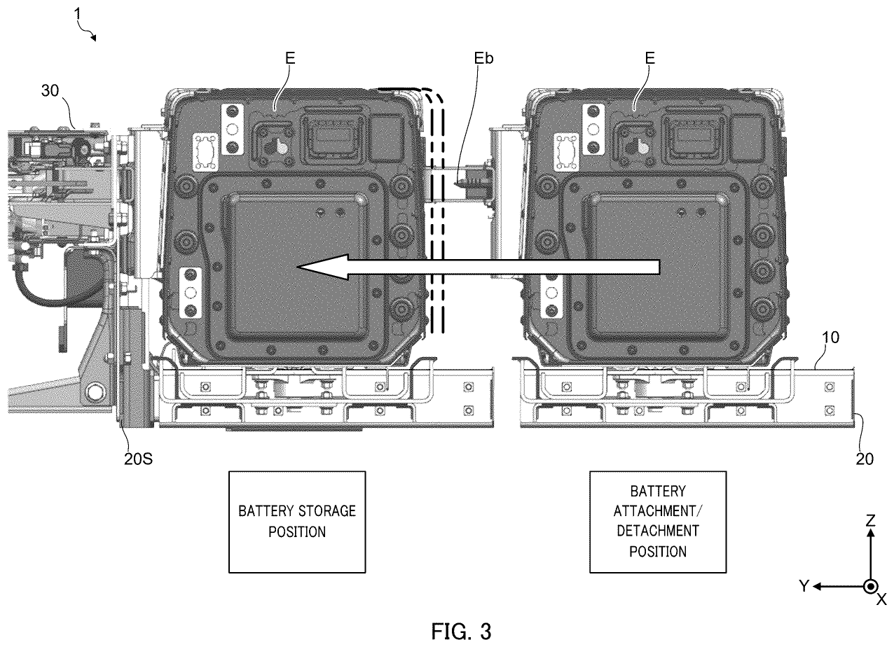

FIG. 1 is a diagram illustrating an example of an application position of battery attachment apparatus 1. FIG. 2 is a perspective view illustrating an example of an overall configuration of battery attachment apparatus 1. FIG. 3 is a diagram illustrating a slide movement of placing table 10 in battery attachment apparatus 1.

Battery attachment apparatus 1 is mounted on an electric vehicle or a hybrid vehicle, and holds a battery used as a drive power source for vehicle C, for example. Note that, in FIG. 1, large vehicle C such as a truck is described as an example of a suitable application for battery attachment apparatus 1.

Battery attachment apparatus 1 holds battery E fixed to vehicle frame Cf of vehicle C, and allows battery E to be detachable from vehicle frame Cf of vehicle C as necessary, for example. Battery attachment apparatus 1 is attached, for example, to a side surface of vehicle frame Cf. Vehicle frame Cf of vehicle C (for example, a steel frame material having a U-shaped cross section) extends along the front-rear direction of vehicle C on both the left and right sides of vehicle C, and supports the vehicle body and various on-board devices.

Battery E is, for example, a high-voltage battery that supplies operating power for driving vehicle C. As battery E, for example, a 200 V class lithium-ion battery is used.

Note that FIG. 1 illustrates an aspect in which one battery E is attached to each of the left and right sides of vehicle frame Cf, and two battery attachment apparatuses 1, each holding one of the two batteries E separately, are provided. The following description assumes that two battery attachment apparatuses 1 have the same configuration, and describes only a configuration of battery attachment apparatus 1 mounted on the minus Y side (that is, the right side surface of vehicle C) of the two battery attachment apparatuses 1.

Battery attachment apparatus 1 is composed of placing table 10 on which battery E is placed, slide rail base 20 that supports placing table 10 in a slidable manner, and battery fixing part 30 (see FIG. 3).

Slide rail base 20 includes slide rail base portion 20b attached to the outer side surface (here, the right side surface) of vehicle frame Cf, and is constituted by two guide members 20a that extend in the horizontal direction from slide rail base portion 20b toward the outside of vehicle C (that is, the minus Y-direction side), for example. Slide rail base 20 guides placing table 10 in a slidable manner between the battery storage position (FIG. 2, left diagram) and the battery attachment/detachment position (FIG. 2, right diagram) in vehicle C (FIG. 3).

Note that, guide member 20a is configured, for example, in a nested manner, with the distal end guide member stored within the base guide member. That is, guide member 20a expands and contracts when the distal end guide member is drawn out from the base guide member to the vehicle outside (that is, the minus Y-direction side).

Placing table 10 is a base on which battery E is placed, and is disposed on two guide members 20a so as to span between two guide members 20a of slide rail base 20, for example. Placing table 10 is slidable along the extension direction (+Y direction) of two guide members 20a of slide rail base 20.

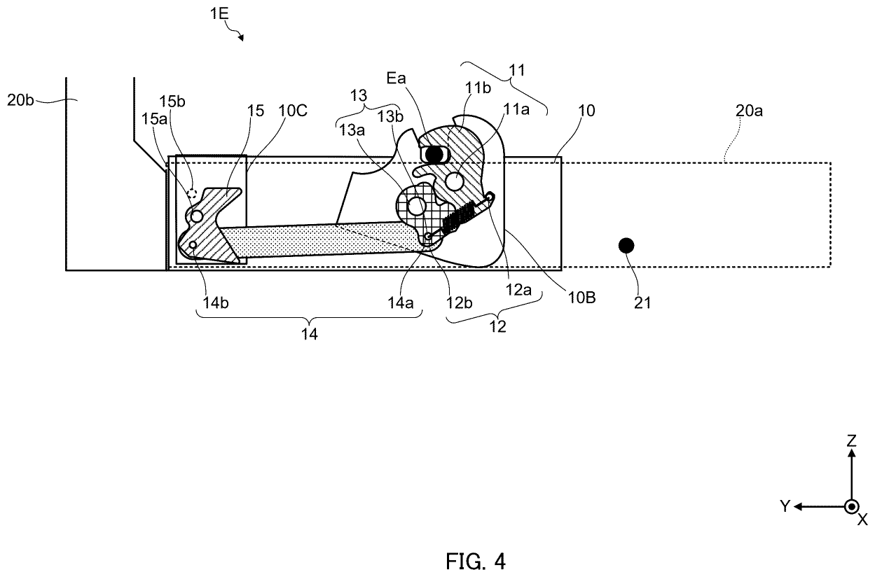

The upper surface of placing table 10 constitutes base part 10a on which battery E is placed. Base part 10a of placing table 10 has, for example, a step shape in which a central portion between two guide members 20a is recessed more than both sides. Further, hole part 10aa is formed in the central portion of base part 10a of placing table 10, and lock mechanism 1E for locking battery E to placing table 10 is disposed at hole part 10aa. That is, lock mechanism 1E is attached to base part 10a of placing table 10 via latch bracket 10B and cam bracket 10C such that latch 11 is exposed from base part 10a of placing table 10 (described later with reference to FIG. 4).

Note that the left diagram of FIG. 2 illustrates a state in which placing table 10 is in the battery storage position of vehicle C, and the right diagram of FIG. 2 illustrates a state in which placing table 10 is drawn out from vehicle C to the battery attachment/detachment position.

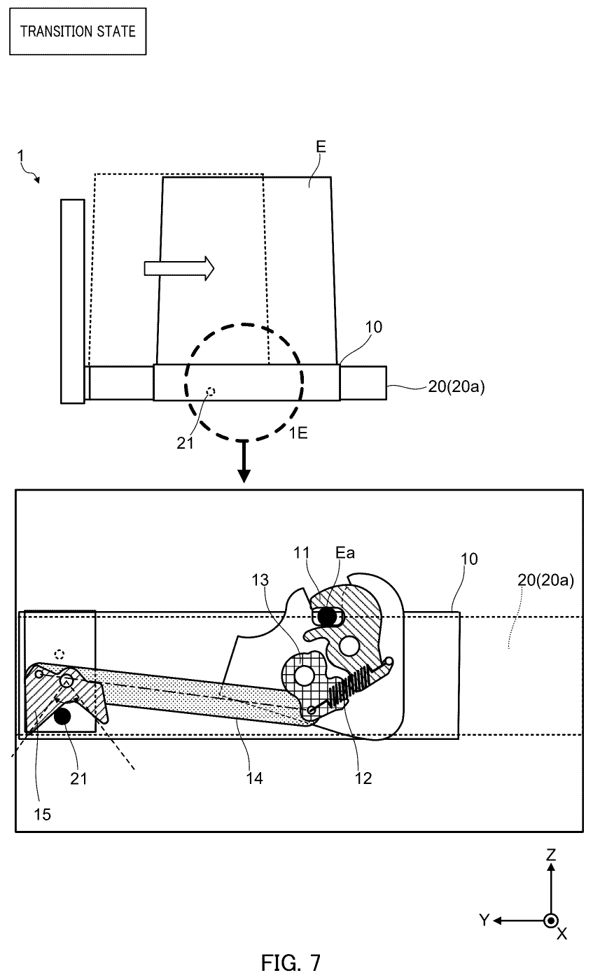

Battery fixing part 30 fixes battery E to the side surface of vehicle frame Cf when placing table 10 is in the battery storage position of vehicle C. The way of fixing battery fixing part 30 is not limited, but battery fixing part 30 is, for example, a latch mechanism attached to a side surface of vehicle frame Cf, and when placing table 10 is in the battery storage position of vehicle C, battery fixing part 30 engages with striker Ec (see FIG. 7) attached to the side surface of battery E to fix battery E to the side surface of vehicle frame Cf. Note that, for an example of the configuration of battery fixing part 30, refer to, for example, PTL 2 of the prior application by the applicant of the present application.

When storing battery E in vehicle C, battery E is placed on placing table 10 when placing table 10 is in the battery attachment/detachment position. Then, battery E is slid on slide rail base 20 in a state of being placed on placing table 10, and is guided from the battery attachment/detachment position to the battery storage position. Then, battery E is fixed to vehicle frame Cf at the battery storage position by battery fixing part 30, for example. At this time, the storage of battery E in vehicle C is completed by connecting terminal portion Eb of battery E to a connector (not illustrated) in vehicle C.

When removing battery E from vehicle C, first, the fixed state of battery E to vehicle frame Cf is released at battery fixing part 30, for example. Then, battery E is slid on slide rail base 20 in a state of being placed on placing table 10, and is guided from the battery storage position in vehicle C to the battery attachment/detachment position. Then, battery E is lifted by a battery exchanger of a battery exchange station at the battery attachment/detachment position, and removed from vehicle C, for example.

Note that, for an example of the operation of the battery exchanger in the battery exchange station, refer to PTL 1 of the prior application by the applicant of the present application, for example.

Here, battery attachment apparatus 1 according to the present embodiment is characterized in that lock mechanism 1E (see FIG. 2) is capable of automatically switching the lock/unlock of the holding state of battery E along with the slide movement of placing table 10.

Battery attachment apparatus 1 locks the holding state of battery E when placing table 10 is in the battery storage position, and unlocks (releases the lock) the holding state of battery E when placing table 10 is in the battery attachment/detachment position. Note that the state in which the holding state of battery E is locked is a state in which battery E cannot be removed from placing table 10, and the state in which the holding state of battery E is unlocked is a state in which battery E can be removed from placing table 10.

Hereinafter, a configuration of lock mechanism 1E provided in battery attachment apparatus 1 according to the present embodiment will be described in detail.

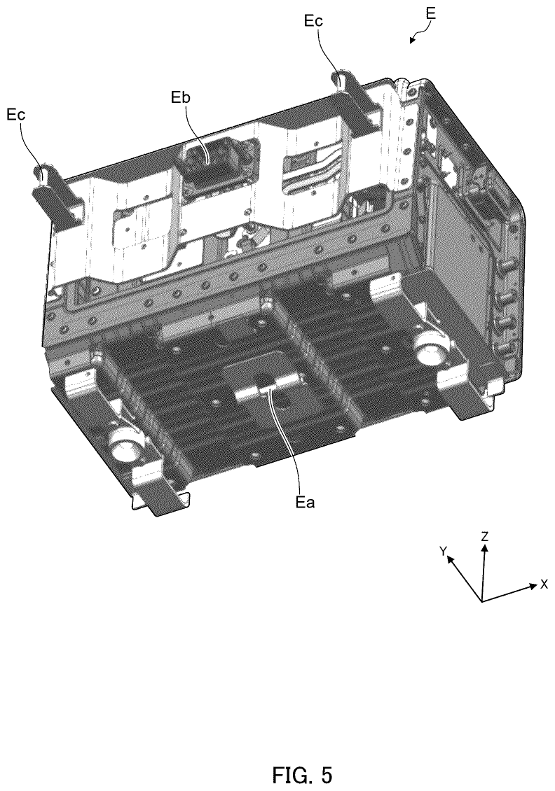

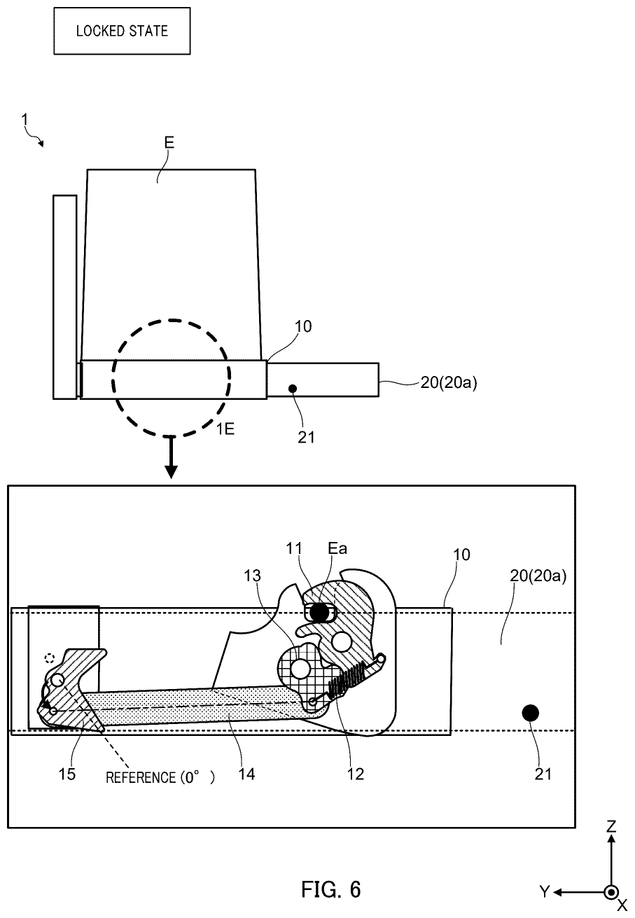

FIG. 4 is a diagram illustrating an example of a configuration of lock mechanism 1E of battery attachment apparatus 1. FIG. 5 is a perspective view of lock mechanism 1E of battery attachment apparatus 1 as viewed from the lower side. FIG. 6 is a diagram illustrating an assembly process of lock mechanism 1E of battery attachment apparatus 1.

FIG. 5 is a diagram illustrating an example of a configuration of striker Ea attached to battery E.

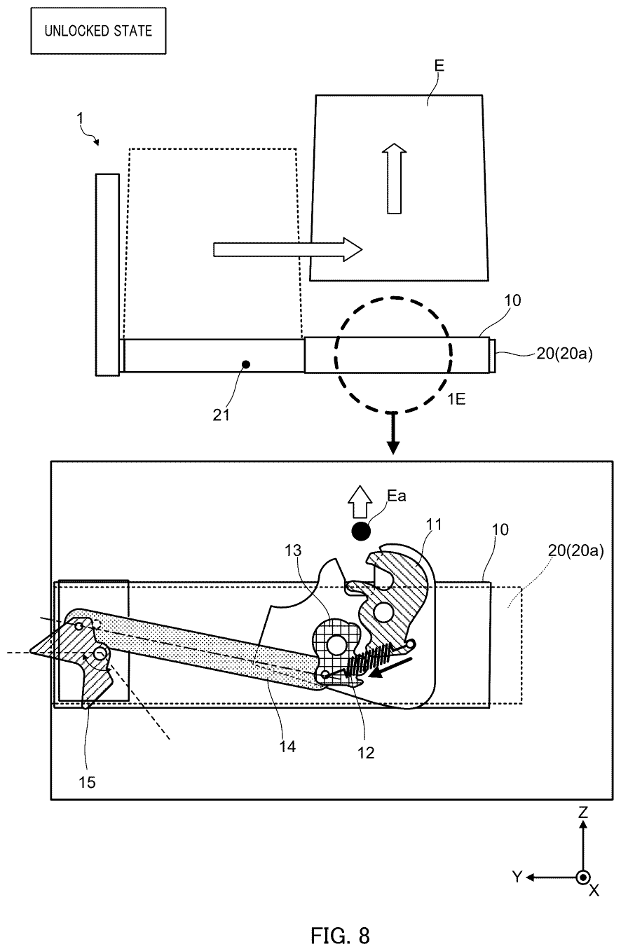

FIGS. 6, 7, and 8 are diagrams for describing an operation of lock mechanism 1E of battery attachment apparatus 1. Note that FIG. 6 illustrates a locked state, FIG. 7 illustrates a transition state between a locked state and an unlocked state, and FIG. 8 illustrates an unlocked state.

Lock mechanism 1E of battery attachment apparatus 1 is a mechanism that locks battery E to a state in which battery E cannot be removed from placing table 10 by engaging with striker Ea (FIG. 5) attached to the lower surface of battery E. Striker Ea is, for example, a rod-like member, and is attached to the lower surface of battery E with a bracket such that striker Ea extends in the ±X direction at a position protruding from the lower surface side of battery E.

Note that, when battery E is placed on placing table 10, striker Ea on the lower surface of battery E is aligned with the position of lock mechanism 1E (the position of hook 11b described later).

Slide rail base 20 includes fixing pin 21 for cam rotation (see FIGS. 2 and 4).

Fixing pin 21 is attached to the side surfaces of two guide members 20a so as to span between two guide members 20a of slide rail base 20 (that is, so as to extend in the +X direction), for example. Note that, fixing pin 21 is located on the lower side of base part 10a of placing table 10, for example.

The attachment position of fixing pin 21 is a position in which fixing pin 21 is engaged with (that is, brought into contact with) release cam 15 attached to placing table 10 when placing table 10 slides on slide rail base 20. Then, when placing table 10 slides on slide rail base 20, fixing pin 21 engages with release cam 15 and rotates release cam 15.

Note that, in the present embodiment, fixing pin 21 is disposed on the minus Y direction side with respect to placing table 10 when placing table 10 is in the battery storage position. Further, fixed pin 21 is disposed in a position where fixing pin 21 engages with release cam 15 attached to placing table 10 when placing table 10 slides from the battery storage position to the battery attachment/detachment position in the minus Y direction.

Placing table 10 includes latch 11, spring 12, latch cam 13, link rod 14, and release cam 15. Note that, in the present embodiment, these members are attached to base part 10a of placing table 10 at the position of hole part 10aa of placing table 10 via latch bracket 10B and cam bracket 10C (see FIGS. 2 and 4).

Latch 11 includes hook 11b for engaging with striker Ea attached to the upper end of battery E, and is rotatably supported with respect to placing table 10. In the present embodiment, latch 11 is supported at the center position of latch 11 by support pin 11a in a rotatable manner around the X-axis with respect to placing table 10 via bracket 10B. Latch 11 is disposed such that hook 11b is exposed from base part 10a of placing table 10, with the clamping portion of hook 11b directed in the plus Y direction.

When latch 11 is at the rotation angle illustrated in FIG. 6, latch 11 engages with striker Ea attached to battery E via hook 11b, and fixes battery E on placing table 10. Then, when latch 11 rotates from the rotation angle illustrated in FIG. 6 to the rotation angle illustrated in FIG. 8, the engaged state between hook 11b and striker Ea is released, thus allowing battery E to be removed from placing table 10.

Spring 12, which applies a pulling force to rotate latch 11 clockwise around the X-axis, is connected to the lower end side of latch 11. When release cam 15 is at the rotation angle illustrated in FIG. 6 (hereinafter referred to as “locking rotation angle”), the pulling force from spring 12 is small (or latch 11 receives a counterclockwise pushing force from spring 12), and thus, latch 11 maintains an engaged state with striker Ea attached to battery E at hook 11b. On the other hand, when release cam 15 is at the rotation angle illustrated in FIG. 8 (hereinafter referred to as the “unlocking rotation angle”), the pulling force from spring 12 is large, and thus latch 11 operates to release the engaged state between hook 11b and striker Ea.

Spring 12 applies a pulling force to latch 11 to rotate latch 11 in the clockwise direction. First end 12a of the end portion of spring 12 on the minus Y side is connected to the lower end side of latch 11. Second end 12b of the end portion of spring 12 on the plus Y side is connected to first end 14a of the end portion of link rod 14 on the minus Y side. Note that the plus Y side is the inner side in the vehicle width direction, and the minus Y side is the outer side in the vehicle width direction. That is, spring 12 applies a pulling force along the Y-axis direction (vehicle width direction) to latch 11.

Note that the connection position between spring 12 and link rod 14 (that is, the position of second end 12b of spring 12) is not fixed with respect to placing table 10, and the position of second end 12b with respect to first end 12a of spring 12 (that is, the length of spring 12) changes along with the swinging motion of link rod 14. That is, the pulling force exerted by spring 12 on latch 11 varies along with the swinging motion of link rod 14.

Link rod 14 swings to the left and right (that is, in the +Y direction) in conjunction with the rotation operation of release cam 15, and changes the relative position of second end 12b side of spring 12 with respect to latch 11. First end 14a of the end portion of link rod 14 on the minus Y side is rotatably connected to second end 12b side of spring 12. Further, second end 14b of the end portion of link rod 14 on the plus Y side is rotatably connected to release cam 15. Note that the connection portion between first end 14a of link rod 14 and second end 12b of spring 12 is, for example, a pin joint connection, and is not fixed to placing table 10. Similarly, the connection portion between second end 14b of link rod 14 and release cam 15 is, for example, a pin joint connection, and is not fixed to placing table 10. Thus, link rod 14 swings along the direction (that is, the Y-axis direction) in which link rod 14 and spring 12 are connected to each other along with the rotation operation of release cam 15, and changes the relative position of spring 12 with respect to latch 11.

In the present embodiment, link rod 14 swings along the ±Y direction while changing the rod axis direction with respect to the Y-axis (which represents the extending direction of link rod 14; same applies hereinafter) in conjunction with the rotation operation of release cam 15. Specifically, link rod 14 swings such that the rod axis direction changes from a predetermined angle on the minus side (for example, −10 degrees) with respect to the Y-axis to a predetermined angle on the plus side (for example, +30 degrees) in conjunction with the rotation operation of release cam 15.

One end of release cam 15 is rotatably connected to second end 14b side of link rod 14. When placing table 10 slides, release cam 15 rotates by coming into contact with fixing pin 21 attached to slide rail base 20, and causes link rod 14 to swing to the left and right (that is, in the ±Y direction). Thus, the relative position of second end 12b side of spring 12 with respect to latch 11 changes, the pulling force exerted by spring 12 on latch 11 changes, and the engaged state between hook 11b and striker Ea changes.

In the present embodiment, release cam 15 is supported at the center position of release cam 15 by support pin 15a in a rotatable manner around the X-axis with respect to placing table 10. Further, the contact portion that comes into contact with fixing pin 21 of release cam 15 is formed in a V shape in a side view, for example.

Further, in cam bracket 10C for attaching release cam 15 to placing table 10, a stopper fixing pin 15b serving as a rotation stopper is disposed near release cam 15. That is, the rotation stops when release cam 15 rotates to the position of stopper fixing pin 15b. Here, stopper fixing pin 15b restricts the unlocking rotation angle of release cam 15. Under the restriction of stopper fixing pin 15b, release cam 15 according to the present embodiment rotates clockwise from 0 degrees to 128.8 degrees, which is the unlocking rotation angle illustrated in FIG. 8, with support pin 15a as the rotation center, when the locking rotation angle illustrated in FIG. 6 is set to 0 degrees.

Latch cam 13 is supported by support pin 13a in a rotatable manner around the X-axis with respect to placing table 10 at a position adjacent to latch 11. Latch cam 13 is rotatably connected to first end 14a of link rod 14 at one end (here, the position of hole portion 13b), and rotates in conjunction with the rotation of release cam 15.

When release cam 15 reaches the locking rotation angle illustrated in FIG. 6, latch cam 13 rotates to come into contact with latch 11, thus functioning as a stopper to prevent the rotation of latch 11. Further, when release cam 15 reaches the unlocking rotation angle illustrated in FIG. 8, latch cam 13 rotates to a state in which latch cam 13 is not in contact with latch 11, thus allowing the rotation of latch 11.

Latch cam 13 is not an essential component in battery attachment apparatus 1, but can usefully enhance the locked state of battery E. That is, in a case where latch cam 13 is not provided and battery E is in the locked state, the function to maintain the locking rotation angle does not act on latch 11. For this reason, when a force that forcibly pulls battery E from the outside is exerted, latch 11 may possibly rotate due to the force and release the lock.

Note that, in the present embodiment, first end 14a of link rod 14 is pin-connected to hole portion 13b formed at one end of latch cam 13, and second end 12b of spring 12 is attached to hole portion 13b.

### Operation of Lock Mechanism 1E of Battery Attachment Apparatus 1

Next, an operation of lock mechanism 1E of battery attachment apparatus 1 according to the present embodiment will be described with reference to FIGS. 6 to 8.

In lock mechanism 1E of battery attachment apparatus 1 according to the present embodiment, as placing table 10 slides with respect to slide rail base 20 and the rotation angle of release cam 15 changes, the pulling force of spring 12 changes and the engaged state between hook 11b and striker Ea changes, thus automatically switching between the lock/unlock of the holding state of battery E.

Specifically, as illustrated in FIG. 6, when placing table 10 is in the battery storage position, link rod 14 is positioned on the minus Y direction side within the swingable range, with the rod axis located on the lower side of the rotation center of release cam 15. At this time, the length of spring 12 is shorter than that in a normal state (that is, a free length), and thus spring 12 applies a pushing force to latch 11 to rotate latch 11 in the counterclockwise direction around the X-axis. In addition, at this time, latch cam 13 is in contact with latch 11, and thus the rotation of latch 11 is restricted.

That is, in the state illustrated in FIG. 6, latch 11 maintains a state in which hook 11b is engaged with striker Ea, and locks the holding state of battery E.

Here, as illustrated in FIG. 7, when placing table 10 slides from the battery storage position (FIG. 6) to the battery attachment/detachment position side, fixed pin 21 comes into contact with release cam 15, and release cam 15 receives a pushing force from fixing pin 21 and rotates around support pin 15a as a rotation center in the clockwise direction around the X-axis. Thus, link rod 14 gradually rotates such that the rod axis faces upward with respect to the rotation center of release cam 15, and link rod 14 moves to the plus Y-direction side within the swingable range. Further, this rotates latch cam 13 to release the contact with latch 11.

Note that, in the transition state in FIG. 7, the length of spring 12 is only slightly longer than the normal state (that is, the free length). As such the pulling force that acts on latch 11 from spring 12 is weak, and the engaged state between hook 11b and striker Ea is maintained.

Here, as illustrated in FIG. 8, when placing table 10 further slides from the position in FIG. 7 to the battery attachment/detachment position side, release cam 15 receives the pressing force from fixing pin 21 and further rotates around support pin 15a as the rotation center in the clockwise direction around the X-axis. Thus, link rod 14 further rotates such that the rod axis faces upward with respect to the rotation center of release cam 15, and link rod 14 moves to the plus Y-direction side within the swingable range.

When release cam 15 rotates to the state illustrated in FIG. 8, the length of spring 12 becomes longer than the length in the normal state (that is, the free length), and thus spring 12 applies a pulling force to latch 11 to rotate in the clockwise direction around the X-axis. Thus, latch 11 releases the engaged state between hook 11b and striker Ea, thus unlocking the holding state of battery E.

Lock mechanism 1E of battery attachment apparatus 1 according to the present embodiment operates as described above, and automatically switches the locking/unlocking of the holding state of battery E as placing table 10 slides with respect to slide rail base 20.

### Effects

As described above, in battery attachment apparatus 1 according to the present embodiment,
slide rail base 20 includes
fixing pin 21 for cam rotation,
placing table 10 includes
latch 11 that is rotatably supported by and attached to placing table 10 and includes hook 11b for engaging with striker Ea attached to battery E at the first end,
spring 12 that includes first end 12a connected to the second end side of latch 11 and applies a pulling force to the second end side of latch 11,
link rod 14 that includes first end 14a connected to the second end 12b side of spring 12, and
release cam 15 that is rotatably connected to the second end 14b side of link rod 14, and swings link rod 14 by rotating by coming into contact with fixing pin 21 along with the slide movement of placing table 10, and
as placing table 10 slides with respect to slide rail base 20 and the rotation angle of release cam 15 changes, the pulling force of spring 12 changes and the engaged state between hook 11b and striker Ea changes, thus switching between the lock/unlock of the holding state of battery E.

According to battery attachment apparatus 1 of the present embodiment, the switching between lock/unlock of the holding state of battery E (here, the holding state related to the movement restriction of battery E in the up-down direction) can be automatically performed along with the slide movement of placing table 10 on slide rail base 20. That is, this can eliminate the need for the user to manually perform a lock release operation using an operation mechanism such as a lever or a cable.

With such a configuration, it is possible to realize switching between locking and unlocking of the holding state of battery E without the need for a complicated operation, and thus the configuration is particularly useful for a battery exchange system using a robot (for example, a battery exchanger).

Further, according to battery attachment apparatus 1 of the present embodiment, even in a case where the length of slide rail base 20 or the movable distance of placing table 10 on slide rail base 20 is changed in design to accommodate various vehicle types, the components of lock mechanism 1E (that is, latch 11, spring 12, link rod 14, cam, and the like) can be used in common.

Thus, the cost can be reduced by using components in common.

The present invention is not limited to the above-described embodiments, and can be applied to various modifications.

In the above embodiment, an example of the connection state of latch 11, spring 12, latch cam 13, link rod 14, and release cam 15 in battery attachment apparatus 1 of the present invention has been described. In battery attachment apparatus 1 of the present invention, however, these members may be indirectly connected to each other via a link bracket or the like.

Further, in the above embodiment, as an example, slide rail base 20 used in battery attachment apparatus 1 of the present invention is composed of extendable and contractible guide member 20a. However, slide rail base 20 used in the present invention may not be extendable and contractible.

While the present invention has been described in detail with reference to specific embodiments, these embodiments are presented by way of example and are not intended to limit the scope of the invention. The technology described in the claims includes various modifications and variations of the specific examples illustrated above.

### INDUSTRIAL APPLICABILITY

According to the battery attachment apparatus of the present invention, battery exchange can be more easily performed.

This application is entitled to and claims the benefit of Japanese Patent Application No. 2024-73917 filed on Apr. 30, 2024, the disclosure each of which including the specification, drawings and abstract is incorporated herein by reference in its entirety.

### REFERENCE SIGNS LIST

1 Battery attachment apparatus
1E Lock mechanism
10 Placing table
10a Base part
10aa Hole part
10B Latch bracket
10C Cam bracket
11 Latch
11a Support pin
11b Hook
12 Spring
13 Latch cam
14 Link rod
15 Release cam
20 Slide rail base
20a Guide member
20b Slide rail base portion
21 Fixing pin
21B Pin bracket
30 Battery fixing part
C Vehicle
Cf Vehicle frame
E Battery
Ea Striker
Eb Terminal portion

1. A battery attachment apparatus, comprising:
a placing table on which a battery is placed; and
a slide rail base configured to support the placing table in a slidable manner,
wherein the slide rail base includes a fixing pin for cam rotation,
wherein the placing table includes
a latch rotatably attached to the placing table and including a hook configured to engage with a striker attached to the battery,
a first cam configured to rotate by coming into contact with the fixing pin when the placing table slides, and
a spring and a link rod configured to connect the latch and the first cam, and
wherein the spring includes a first end connected to the latch and a second end connected to the link rod in a swingable manner such that a pulling force is exerted on the first end side.

2. The battery attachment apparatus according to claim 1,
wherein the link rod includes a first end connected to the first cam and a second end connected to the second end of the spring, and
wherein the link rod swings along a direction in which the link rod and the spring are connected to each other along with a rotation operation of the first cam, and changes a relative position of the spring with respect to the latch.

3. The battery attachment apparatus according to claim 1, wherein as the placing table slides with respect to the slide rail base and comes into contact with the fixing pin to change a rotation angle of the first cam, the pulling force of the spring changes and an engaged state between the hook and the striker changes so as to switch between locking and unlocking of a holding state of the battery.

4. The battery attachment apparatus according to claim 1,
wherein a holding state of the battery is set to a locked state when the placing table is at a storage position of the battery, and
wherein the holding state of the battery is set to an unlocked state when the placing table is at an attachment/detachment position of the battery.

5. The battery attachment apparatus according to claim 1,
wherein the placing table further includes a second cam rotatably connected to a first end side of the link rod and configured to rotate in conjunction with a rotation of the first cam, and
wherein when a holding state of the battery is a locked state, the second cam comes into contact with the latch so as to function as a stopper for preventing a rotation of the latch, whereas when the holding state of the battery is an unlocked state, the second cam is separated from the latch.

6. A vehicle comprising the battery attachment apparatus according to claim 1.
